(19) United States
(12) Patent Application Publication
(10) Pub. No.: US 2025/0390898 A1
(43) Pub. Date: Dec. 25, 2025

(54) GENRE-ADAPTIVE ANALYTIC EXPONENTIAL MODELING FOR ACCURATE TIME SERIES FORECASTING WITH MINIMAL DATA

(71) Applicant: NBCUniversal Media, LLC, New York, NY (US)

(72) Inventors: Yong Yi Bay, Waukee, IA (US); Jing Chen, Newton, MA (US)

(21) Appl. No.: 18/748,929

(22) Filed: Jun. 20, 2024

(51) Int. Cl. G06Q 30/0202

(52) U.S. Cl. CPC G06Q 30/0202

(57) ABSTRACT

An improved method is provided to provide efficient and accurate prediction/forecasting of inflow for content titles with limited historical data. The method may include dynamic generation of training data to be supplied to a forecasting model for predicting a performance metric of a content title of interest with limited historical data, based on the limited historical data and/or historical data of one or more other content titles with sufficient history. As such, instead of the limited historical data of the content title, the forecasting model may study from a broader range of historical data that may have similar trends as the title of interest.

### BACKGROUND

This disclosure relates generally to improved prediction/forecasting of metrics associated with provided content titles. More specifically, the disclosure relates to improved prediction/forecasting techniques for content titles having limited historical data.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Content providers (e.g., streaming services) that provide content in exchange for paid subscription fees and/or other revenue sources are becoming increasingly prevalent. To maintain and increase viewership, streaming platforms typically provide increased content offerings of high-quality content. Introduction of new high-quality content can be quite costly and, thus, it is desirable to measure the successfulness of a content title (e.g., a piece of content, a collection of content, such as content series, a current season of a content series, and/or an aggregation of previous seasons of a content series) to maintain existing subscribers and/or capture new subscribers.

In the content provision (e.g., streaming) space, the “inflow” for a given title is defined as its volume of first views among subscribers. “Inflow” constitutes a key metric regarding the success of the title. The ability to monitor and forecast this metric accurately offers enormous business value and competitive advantage to streaming platforms. For example, the inflow measurement may be used to identify the effectiveness of particular titles to draw in and/or retain paid subscribers. As may be appreciated, this may greatly impact business decisions to retain content on the platform, generate new content associated with particular titles, etc. The inflow may be measured at different intervals of time. For example, inflow measurements may be determined over 1 month, 2 months, 6 months, etc. from today or from a user-specified date. The inflow may focus on all users of a content provision platform and/or may target particular users, such as paid subscribers and/or particular paid subscribers (e.g., those on an ad-supported tier, a premium tier, and/or a non-premium tier).

While the embodiments described herein focus primarily on inflow forecasting, the described techniques are not limited to improved forecasting of this metric alone. Indeed, with proper tuning, the current techniques may be used to provide improved forecasting of other content provision metrics, such as number of hours watched of a particular title, ad revenue of a particular title (which might include number of ads watched, etc.) and other useful metrics.

Recently, time-series methodologies have demonstrated a level of success for metric forecasting by incorporating deep learning and/or machine learning models to study historical data of a content title. For example, given sufficient historical data, time-series methodologies based on Gradient Boosting Machines (GBMs) may provide accurate forecasting of title popularity and/or inflow for a wide range of content titles. Indeed, with proper modifications, such methodologies may be capable of providing reasonable forecasting for eligible content titles with seasonal trends (e.g., patterns occurring when a time-series is affected by seasonal factors such as time of year, day of week, etc.) and those without seasonal trends.

However, it is also recognized that such methodologies often struggle to provide forecasting for content titles that have limited historical data for the GBM models to study from. Specifically, these methodologies become highly erroneous when faced with content titles that have less than 90 days of data, such as newly released titles. This is because the models are less likely to identify any patterns within the limited historical data that these models are optimized to learn and forecast. As a result, the predicted success of the titles having limited historical data evaluated with existing time-series methodologies may be subject to a great level of uncertainty, leading to ineffective and/or inefficient streaming platform resource allocation. Therefore, new techniques for forecasting title inflow or other useful metrics suitable for content titles with limited historical data on streaming platform may be desirable.

### SUMMARY

Certain embodiments commensurate in scope with the originally claimed subject matter are summarized below. These embodiments are not intended to limit the scope of the claimed subject matter, but rather these embodiments are intended only to provide a brief summary of possible forms of the subject matter. Indeed, the subject matter may encompass a variety of forms that may be similar to or different from the embodiments set forth below.

In accordance with an aspect of the present disclosure, a method may include receiving historical data of a metric associated with a content title of interest, where the content title of interest belongs to a content genre. The method may include obtaining a genre archetype corresponding to the content genre, where the genre archetype is generated based on historical data of the metric associated with one or more other content titles, where the one or more other content titles belong to the content genre. The method may also include performing a transformation on the genre archetype to generate training data for a forecasting model to forecast the metric associated with the content title. The method may further include forecasting the metric associated with the content title of interest using the generated training data applied to the forecasting model.

In accordance with another aspect of the present disclosure, a method may include determining if a content title of interest is associated with at least a certain number of days of historical data of a metric. When the content title of interest is associated with at least the certain number of days of the historical data of the metric, the method may include generating training data based on a title decay rate. When the content title of interest is not associated with at least the certain number of days of the historical data of the metric, the method may include generating training data based on a genre decay rate, where the genre decay rate is associated with a content genre of the content title of interest and generated based on one or more other content titles, where the one or more content titles belong to the content genre. The method may further include forecasting the metric associated with the content title of interest using the generated training data applied to a forecasting model.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a diagram of a system to dynamically generate training data for efficient and accurate prediction/forecasting of metrics associated with content titles with limited historical data, in accordance with certain aspects of the present technique;

FIG. 2 is a flowchart illustrating a process by which forecasting services may dynamically generate training data based upon whether a title with limited historical data is associated with a seasonal trend, in accordance with certain aspects of the present technique;

FIG. 3A is a flowchart illustrating a process for generating a genre archetype specific to a genre, in accordance with certain aspects of the present technique;

FIG. 3B is a flowchart illustrating a process for transforming a genre archetype to generate a transformed genre archetype specific to a seasonal title of interest, in accordance with certain aspects of the present technique;

FIG. 4 is a diagram illustrating an example implementation of the timeframe standardization, in accordance with certain aspects of the present technique;

FIG. 5 is a diagram illustrating an example implementation of the generation of a genre archetype, in accordance with certain aspects of the present technique;

FIG. 6 is a diagram illustrating an example implementation of the generation of training data based on a genre archetype, in accordance with certain aspects of the present technique;

FIG. 7 is a flowchart illustrating a process for generating training data for forecasting inflow of a non-seasonal title of interest with limited history based on a dynamically fitted exponential curve, in accordance with certain aspects of the present technique; and

FIG. 8 is a diagram illustrating an example implementation of the decay rate calculation, in accordance with certain aspects of the present technique.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various aspects of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As noted above, there remains a need for improved prediction/forecasting of metrics associated with content provision via a content provision platform. With this in mind, present embodiments are directed to improved prediction/forecasting techniques for content titles with limited historical data. Training data may be dynamically generated to be used in a forecasting model for forecasting a metric of a content title. Specifically, the training data may be generated based on the limited historical data associated with the particular content title and/or historical data associated with one or more other content titles. As such, the forecasting model may utilize carefully prepared training data to provide efficient and accurate prediction/forecasting of metrics associated with a content title with limited historical data.

In addition, certain aspects of the improved prediction/forecasting techniques described herein may be classified as glass-box transfer learning methodologies, enabling high interpretability and transparency for their implementation. Specifically, the techniques are structured for direct interpretability and the prediction/forecasting of metrics made by the corresponding forecasting model is more understandable and explainable, as opposed to that made by the so-called “black box” models. Such high interpretability and transparency may be highly desirable to reduce financial risks associated with the predicted successfulness of a content title. Further, the techniques described herein utilizes transfer learning, where information or knowledge is transferred from one machine learning task to another task to boost performance. In particular, the forecasting model, which is discussed in further detail below, may be trained on data of similar titles with sufficient history, and the knowledge gained from the training is transferred to help forecast a title of interest with limited history. As such, the present embodiments provide a well-performed transfer learning methodology with highly desirable features (e.g., high interpretability and transparency) to predict the potential successfulness of content titles with limited history.

FIG. 1 is a diagram of a system 100 that dynamically generates training data to provide efficient and accurate prediction/forecasting of metrics associated with content titles with limited historical data. As illustrated, the system 100 includes a content provision platform 102. The content provision platform 102 is an electronic service (e.g., software running on servers) that provide content created and/or supplied by a content provider 104 to client players 106 (e.g., via a network 108, such as the Internet). As mentioned above, it may be desirable to identify metrics associated with the content (e.g., metrics associated with specific titles of the content). For example, the content provision platform 102 and/or the content provider 104 may desire to understand the “success” of a particular title (e.g., how the title impacts revenue of the content provision platform 102 and/or content provider 104). Accordingly, the system 100 includes forecasting services 110, which may intake historical performance data (e.g., from the content provision platform 102) of titles. The historical performance data of these titles may be used as training data to train forecasting models of the forecasting services 110. The forecasting service 110 may forecast metrics associated with these titles, which may then be presented to the content provision platform 102 and/or the content provider 104 for further assessment of the titles.

There are many options when it comes to time-series methodologies for forecasting performance (e.g., inflow) of content titles. As an example, Gradient Boosting Machines (GBMs) have a strong reputation for providing successful time-series analysis. GBM provides a powerful tree-ensemble technique that combines several weak learners into strong learners, in which each new model is trained to minimize the loss function (such as mean squared error) of the previous model using gradient descent. In each iteration, the algorithm computes the gradient of the loss function with respect to the predictions of the current ensemble and then trains a new weak model to minimize this gradient. The predictions of the new model are then added to the ensemble, and the process is repeated until a stopping criterion is met.

The success of GBMs lends itself as a-state-of-the-art time-series model for the purposes of forecasting performance metrics (e.g., inflow) for a wide range of content titles. Content titles may be generally categorized into two major categories: content titles with seasonal trends (hereinafter, “seasonal titles”) and content titles without seasonal trends (hereinafter, “non-seasonal titles”), where seasonal trends are patterns occurring when a time-series is affected by seasonal factors such as time of year, day of week, etc. For example, many sports content titles may be considered to be seasonal titles, as viewership of such content titles often drastically increase in concordance with various major sports seasons. In contrast, many day-and-date release films may be considered to be non-seasonal titles, as viewership of such content titles are less likely to be affected by seasonal factors. Hence, seasonal titles and non-seasonal titles are known to have drastically different performance metric trends. Specifically, seasonal titles may have inflow trends with seasonal spikes. In contrast, non-seasonal titles may have inflow trends with gradual decay, where initial spikes may be observed near the release dates.

Because of the drastic difference of performance data trends between seasonal titles and non-seasonal titles, different forecasting models may be developed to accurately forecast for both categories of content titles. For example, a GBM-based forecasting model including curve-fitting techniques may be trained to forecast certain performance metrics (e.g., inflow) of non-seasonal titles. Accordingly, as discussed herein, the forecasting services 110 may dynamically select an appropriate model for each content title. As illustrated, the forecasting services 110 may include a dynamic model selector 112, which may dynamically select a particular model from a plurality of available models based upon identified characteristics of a particular content title. For example, the dynamic model selector 112 may select a particular forecasting model for a particular content title based upon an indication of its association with a seasonal trend. As a more specific example, the dynamic model selector 112 may select a first forecasting model for a seasonal content title and select a second forecasting model for a non-seasonal content title.

Further, various modifications may be dynamically applied to various aspects of the GBM-based forecasting models according to characteristics specific to each content title. Unfortunately, however, many existing GBM-based forecasting models cannot provide forecasting for content titles that have limited historical data for the models to study from. Accordingly, as will be illustrated in more detail below, certain modifications may be dynamically applied to the GBM-based forecasting models based on a length of an existing performance history. That is, when GBM-based forecasting models are used to forecast a performance metric for content titles with limited historical data, the limited raw historical performance data may be analyzed and modified to generate improved training data for more accurate forecasting.

As illustrated, the forecasting services 110 may also include a dynamic training data generator 114, which may dynamically process raw historical performance metric data of a particular title with limited historical data on the content provision platform 102 to generate training data for forecasting performance metrics of the titles via the various forecasting models in the forecasting services 110. For example, the training data may be generated based upon an indication of an association of the particular title with a seasonal trend. As a more specific example, the dynamic training data generator 114 may generate training data for a seasonal content title via a first process and generate training data for a non-seasonal content title via a second process. In some aspects, the training data may be generated based on the limited historical data and/or historical data of one or more other content titles. As such, the forecasting models may utilize carefully prepared training data to provide efficient and accurate prediction/forecasting of metrics associated with the particular content title with limited historical data. This may result in significantly more accurate forecasting of content provision metrics, which may result in better decision making regarding the title (e.g., such as whether to create or purchase additional content similar to and/or associated with the title). Upon identifying a forecast for a title, the forecast may be provided in electronic data to a requestor, such as the content provision platform 102 and/or the content provider 104. In some aspects, the forecast may be provided via a graphical user interface (GUI) (e.g., of the forecasting services 110).

As illustrated, the forecasting services include a computing system 116, e.g., a central computer, that includes one or more processors 118 and one or more memory devices 120. The one or more processors 118 may execute software programs and/or instructions to generate training data, select forecasting models, provide forecast, and so forth. Moreover, the processor(s) 118 may include multiple microprocessors, one or more “general-purpose” microprocessors, one or more special-purpose microprocessors, and/or one or more application specific integrated circuits (ASICS), and/or one or more reduced instruction set (RISC) processors. The memory device(s) 120 may include one or more storage devices, and may store machine-readable and/or processor-executable instructions (e.g., firmware or software) for the processor(s) 118 to execute, such as instructions relating to generate training data. As such, the memory device(s) 120 may store, for example, control software, look up tables, configuration data, and so forth, to facilitate generate training data. In some aspects, the processor(s) 118 and the memory device(s) 120 may be external to the computing system 116. The memory device(s) 120 may include a tangible, non-transitory, machine-readable-medium, such as a volatile memory (e.g., a random access memory (RAM)) and/or a nonvolatile memory (e.g., a read-only memory (ROM), flash memory, hard drive, and/or any other suitable optical, magnetic, or solid-state storage medium).

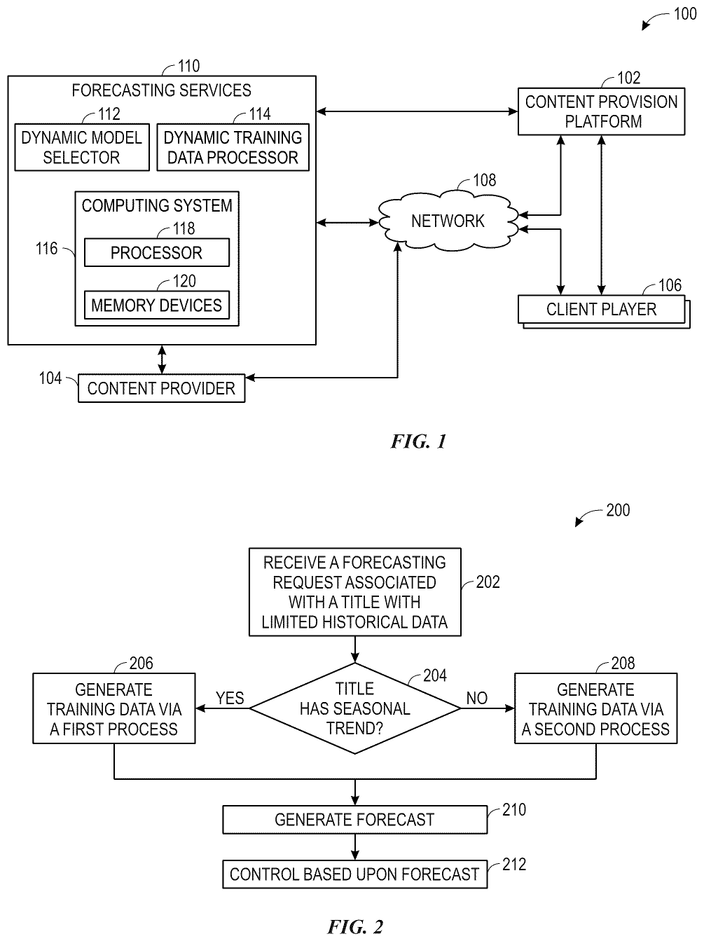

Having discussed an overview of the dynamically adjusted forecasting system 100 of FIG. 1, the discussion turns to dynamic adjustment of training data based on whether a title is associated with a seasonal trend. FIG. 2 is a flowchart illustrating a process 200, by which forecasting services (e.g., the forecasting services 110) may dynamically generate training data based upon whether a title with limited historical data is associated with a seasonal trend. As such, the forecasting service may forecast a performance metric for the title with limited historical data on a content provision platform (e.g., the content provision platform 102).

The process 200 begins with receiving (block 202) a forecasting request associated with a title (i.e., title of interest) with limited historical data. In some aspects, the forecasting request may include metadata data that describes a range of characteristics associated with the title of interest. For example, the forecasting request may include metadata data that may provide an indication of whether the title of interest is expected to have a seasonal trend. In an aspect, the forecasting request may include a name, a theme, a content type, a genre, a subgenre, a keyword list, a style, a release date, a country of origin, a language, a runtime, a crew list, a cast list, or any other metadata data associated with the title of interest.

The process 200 may be a part of a process for forecasting a performance metric for any provided title. For example, the process 200 may be preceded by a decision block to determine whether the title of interest has a limited history (e.g., inflow history, content viewing history, ad viewing history, revenue history, etc.). If the title is determined to have a limited history, a forecasting request may be generated automatically for the forecasting service to execute process 200 accordingly for the said title. If the title is determined to not have a limited history, the title may be directed to a different process for forecasting performance.

Criteria for determining whether a title has a limited history may vary. In an aspect, a title may be considered to have a limited history if the title has a history shorter than a predetermined threshold, which may be any length of time. For example, the title may be considered to have a limited history if the title has a history of less than 90 days. The length of the history of a title may be counted from a title release date, a first available date on the content provision platform 102, or a first available date of performance data. In other aspects, the threshold for determining whether a title has a limited history may be dynamically adjusted. For example, the threshold may be associated with a characteristic of a title. As a more specific example, the time threshold may be dependent on a content type; the time threshold for a documentary may be longer than that for a fictional movie. As another example, the threshold may be optimized based on a comparison of forecasting accuracy between a model with dynamic training and a model without dynamic training. As such, the threshold may be optimized that, for titles having a history shorter than the threshold, the model with dynamic training forecasts better than the model without dynamic training; while, for titles having a history longer than the threshold, the model without dynamic training forecasts better than the model with dynamic training.

The process 200 may include determining (decision block 204) whether the title of interest is associated with a seasonal trend. In some aspects, the title's association with a seasonal trend may be determined upon analyzing historical performance data of the title. For example, through extensive research and rigorous tuning, it has become known that a key indicator of titles benefiting from a varied inflow forecasting technique may be identified based upon certain characteristics being found in their historical performance data. The historical performance data may include the historical data of the performance metric to be forecasted.

With the limited history, the association with a seasonal trend may be determined for a title of interest based on characteristics of the title without extensive analysis of the historical performance data. For example, the title of interest may be determined to be associated with a seasonal trend if the title of interest is associated with a certain genre. As previously discussed, sports-related content titles are generally associated with a seasonal trend; as a result, in some aspects, a sports-related content title may be determined to be associated with a seasonal trend. In some aspects, the determining may be executed manually by an employee of a streaming service (e.g., the content provision platform 102 and/or content provider 104), who may have been trained to distinguish between titles with seasonal trends and titles without.

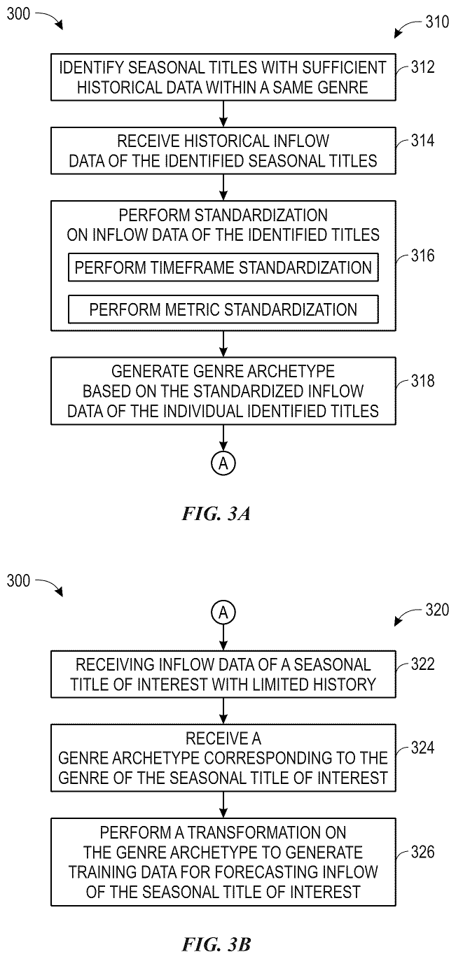

If, at decision block 204, the title of interest is determined to be associated with a seasonal trend, the forecasting services 110 may proceed to generate (block 206) training data via a first process. The forecasting services 110 may receive and analyze historical data of the said performance metric to be forecasted associated with the title of interest. Additionally, the forecasting services 110 may receive and analyze historical data of the said performance metric associated with one or more other content titles, where the one or more other content titles may belong to the same genre as the title of interest and have sufficient historical data available to the forecasting services 110. As such, instead of the limited historical data associated with the title of interest, the forecasting models of the forecasting services 110 may study from a broader range of historical data that may have similar trends as the title of interest. In some aspects, the first process to generate the training data may include generating a genre archetype based on the historical data of the one or more other content titles within the same genre as the title of interest. For example, the genre archetype may be generated by aggregating the historical data of the one or more other content titles within the same genre as the title of interest. Further, the first process may include transforming the generated genre archetypes to generate genre-adaptive training data specific to the content title of interest. Various aspects of the genre archetype and its transformation for generating training data are discussed in further detail below with respect to FIGS. 3A and 3B.

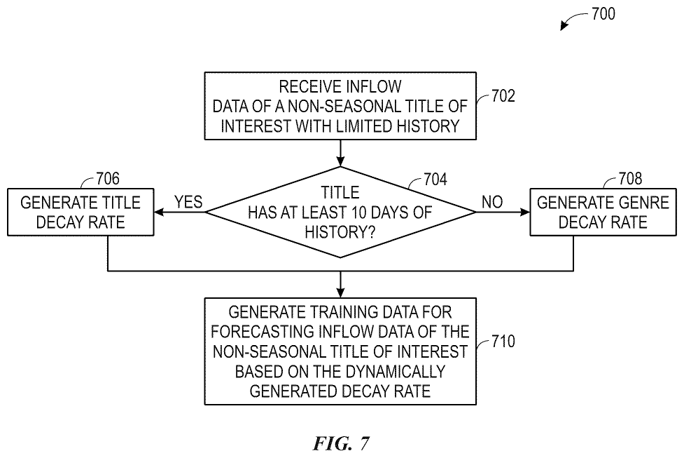

However, if, at decision block 204, the title is determined not to be associated with a seasonal trend, the forecasting services 110 may proceed to generate (block 208) training data via a second process. In an aspect, the forecasting services 110 may receive and analyze historical data of the said performance metric to be forecasted associated with the title of interest. Additionally, the forecasting services 110 may receive and analyze historical data of the said performance metric associated with one or more other content titles, where the one or more other content titles may be associated with the same genre as the title of interest and have sufficient historical data available to the forecasting services 110. As such, instead of the limited historical data associated with the title of interest, the forecasting models of the forecasting services 110 may study from a broader range of historical data that may have similar trends as the title of interest. In an aspect, the second process to generate the training data may include generating a dynamically fitted curve based on the limited historical data associated with the title of interest and/or the historical data associated with the one or more other content titles (see FIG. 7 and its corresponding discussion). The dynamically fitted curve may be generated through polynomial curve fitting, linear curve fitting, and/or exponential curve fitting to provide better forecasting for titles not associated with a seasonal trend. Various aspects of the generation of the dynamically fitted curve are discussed in further detail below with respect to FIG. 7.

Regardless of how the training data is generated, the process 200 may include generating (block 210) a forecast. The generated training data may be inputted into a forecasting model to generate the forecast performance of the title of interest. The forecasting model may be a GBM-based forecasting model or may be selected from a variety of forecasting models in accordance with certain characteristics of the title of interest. For example, a first forecasting model specifically tuned to forecast a performance metric for various titles with seasonal trends may be selected to train the training data generated via the first process; a second forecasting model specifically tuned to forecast a performance metric for various titles without seasonal trends may be selected to train the training data generated via the second process.

Regardless of which forecasting model is used, upon generation of the forecast, the generated forecast may be provided to a requesting entity. In some aspects, the forecast is provided via a graphical user interface (GUI) that provides an indication of the generated forecast. In some aspects, the forecast may be provided via electronic data (e.g., in response to an electronic request for the forecast from a source requestor entity, such as the content provision platform 102 and/or the content provider 104).

The process 200 may include controlling or performing an action (block 212) based upon the generated forecast. In an aspect, a streaming service (e.g., the content provision platform 102 and/or content provider 104) may allocate resources based on the forecasted performance metric of a content title. For example, the streaming service may decide to remove a content from the streaming platform if the forecasted performance metric of a content title does not meet certain criteria. As another example, the streaming service may decide to create additional content similar to and/or associated with a title whose forecasted performance metric exceeds certain other criteria. In another aspect, additional forecasted performance metrics associated with the title of interest may be generated through process 200. The action may be controlled or performed based upon the said performance metric and the additional forecasted performance metrics.

Having discussed the dynamic generation of training data based upon whether the title of interest with limited historical data is associated with a seasonal trend, FIGS. 3A and 3B are flowcharts of two processes that may be combined to form a process 300 for generating training data for forecasting inflow of a seasonal title of interest with limited historical data based on a transformed genre archetype. Specifically, FIG. 3A is a flowchart, illustrating a process 310 by which forecasting services (e.g., the forecasting services 110) may generate a genre archetype specific to a genre, where the genre archetype is generated based on eligible seasonal titles within the genre; while FIG. 3B is a flowchart, illustrating a process 320 by which the forecasting services 110 may transform a genre archetype to generate genre-adaptive training data specific to a seasonal title of interest, where the genre archetype is corresponding to a genre of the seasonal title of interest.

In an aspect, the genre archetype of FIG. 3B for generating the training data may be generated through the process 310 of FIG. 3A. In an aspect, the process 310 may be executed after the forecasting services 110 receive a forecasting request for a specific content title, which is associated with a genre. As such, the forecasting services may generate a genre archetype specific to the associated genre. In another aspect, the process 310 may be executed without the forecasting services 110 having any forecasting request. In this aspect, the process 310 may be executed to generate one or more genre archetypes, each specific to a respective genre. As such, when the forecasting services 110 receive a forecasting request for a specific content title at a later time, the forecasting services 110 may select a specific genre archetype from the one or more genre archetypes immediately and proceed to execute the process 320 to transform the specific genre archetype to generate genre-adaptive training data specific to the seasonal training data.

It should be appreciated that the process 300 is not limited to forecasting inflow associated with a seasonal title of interest; instead, the process 300 may be adopted to forecast any performance metric associated with the seasonal title of interest, such as number of hours watched of a particular title, ad revenue of a particular title (which might include number of ads watched, etc.) and other useful metrics. It should also be appreciated that the process 300 may be rearranged to include only certain aspects of the process 310 and certain aspects of the process 320. The process 300 may include additional aspects that are not illustrated herein. The process 320 is not limited to be preceded by the process 310. Instead, the individual elements of the process 310 and that of the process 320 may be arranged in any suitable order to forecast inflow of a seasonal title of interest with limited historical data.

With the foregoing in mind, the process 310 to generate a genre archetype, as illustrated in FIG. 3A, may include identifying (block 312) eligible seasonal titles with sufficient historical data within a same genre. In contrast to the seasonal title of interest, which has limited historical data, the identified eligible seasonal titles may each have historical data spanning over a minimum threshold. In an aspect, only seasonal titles with more than 12 months of historical data may be identified. As such, the identified seasonal titles may have at least 12 months of historical data to generate a genre archetype for the forecasting models of the forecasting services 110 to study from. In another aspect, the minimum threshold may be determined based on the specific applications of the respective embodiments.

Further, the identified seasonal titles may belong to the same genre, such that the identified seasonal titles may have similar historical inflow trends. In an aspect, each content title of the content provision platform 102 and/or content provider 104 is labeled to belong to a respective content genre of one or more content genres. The one or more content genres may be predetermined categories of content titles, each describing a common theme, a content type, a style, or an overall plot of all content titles therein. Hence, a plurality of content titles may be said to belong to a same genre if the plurality of content titles is determined to share one or more characteristics, such as a theme, a content type, a style, an overall plot, or other shared characteristic.

In another aspect, the one or more content genres may be described by one or more classes identified by a machine learning model. As used herein, machine learning models refers to algorithms and statistical models that may be used to perform a specific task without using explicit instructions, relying instead on patterns and inference. In particular, a machine learning model generates a mathematical model based on data (e.g., sample or training data) in order to make predictions or decisions without being explicitly programmed to perform the task. For example, as characteristics and inflow data of all content titles of the content provision platform 102 and/or content provider 104 are trained by a machine learning model, patterns may be identified via the machine learning model to create one or more classes of content titles, where each of the one or more classes of content titles include certain content titles that have high levels of similarity among each other. As such, the identified seasonal titles within a same content genre, or a same class of content title, may have high levels of similarity.

Having identified the seasonal titles with sufficient historical data within a same genre, the process 310 may include receiving (block 314) historical inflow data of the identified seasonal titles within the same genre. The forecasting services 110 may intake historical inflow data of the identified seasonal titles from the content provision platform 102 and/or content provider 104.

The process 310 may include performing (block 316) standardization on historical inflow data of the identified seasonal titles within the same genre. In an aspect, the standardization includes timeframe standardization and metric standardization. Specifically, the timeframe standardization standardizes the historical inflow data such that the standardized inflow data only contains data within a universal timeframe for all identified seasonal titles. In contrast, the metric standardization standardizes the historical inflow data of each of the identified seasonal titles to exclude extreme datapoints such that the standardized inflow data of each of the identified seasonal titles would not have dominance over other identified seasonal titles with extreme inflows.

The timeframe standardization may be performed on the received historical inflow data first. As discussed previously, the identified seasonal titles all have sufficient historical inflow data, such as historical inflow data of over 12 months; however, the historical inflow data of these titles may have a variety of length. In some aspects, the forecasting services 110 may specify a timeframe to select a portion of the received historical data of the identified seasonal titles. For example, the forecasting services 110 may truncate historical data older than 12 months, such that the remaining data may include an entire year's trend. As another example, the forecasting services 110 may specify a one-year timeframe prior to an evaluation date or an evaluation period as a training period and only preserve historical data within the one-year from the beginning of the training period.

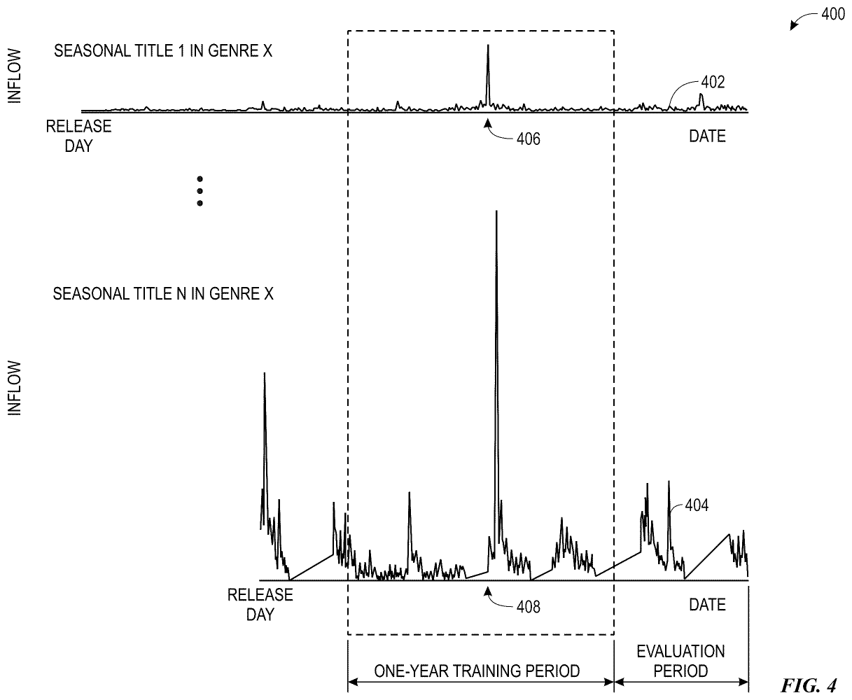

FIG. 4 is a diagram illustrating an example implementation 400 of the timeframe standardization. As illustrated, a plurality of content titles are identified to generate a genre archetype corresponding to a genre (e.g., genre X as illustrated in FIG. 4), where the plurality of content titles include a first seasonal title (e.g., seasonal title 1 as illustrated in FIG. 4) having first historical inflow data 402 and a second seasonal title (e.g., seasonal title N as illustrated in FIG. 4) having second historical inflow data 404. The first seasonal title has a longer history than the second seasonal title, and the first historical inflow data 402 and the second historical inflow data 404 have different lengths. Accordingly, timeframe standardization is performed on the first historical inflow data 402 and the second historical inflow data 404 such that the standardized inflow data only contain data within a universal timeframe for the identified seasonal titles. In the current example, a one-year timeframe prior to the start of an evaluation period is specified as a training period, and only the historical data within the one-year training period is preserved. That is, the first historical inflow data 402 and the second historical inflow data 404 are truncated to produce a first remaining historical inflow data 406 and a second remaining historical inflow data 408.

The discussion returns to block 316 of the process 310 in FIG. 3A. Metric standardization may be performed on the remaining historical inflow data of each individual identified seasonal title to complete the standardization. The metric standardization may include any standardization techniques. For example, for each individual identified seasonal title, the metric standardization may be performed on the corresponding remaining historical inflow data by first subtracting a mean of the inflow data from the inflow data and then scaling the inflow data by a unit variance of the inflow data. Because the inflow data often do not follow a normal distribution, in preferred embodiments, the metric standardization may include a robust standardization technique. As such, for each individual identified seasonal title, the metric standardization may be performed on the corresponding remaining historical inflow data by first subtracting a median of the inflow data from the inflow data and then scaling the inflow data by an interquartile range of the inflow data. In an aspect, metric standardization may be performed on the historical inflow data after timeframe standardization is performed or vice versa.

Through various standardization techniques, the historical inflow data of individual identified seasonal titles may be standardized to generate standardized inflow data of the respective individual identified seasonal titles. With the standardized inflow data of the individual identified seasonal titles, the process 310 may also include generating (block 318) a genre archetype based on the standardized inflow data of the individual identified seasonal titles within the same genre. In an aspect, the standardized inflow data of the individual identified seasonal titles within the same genre are aggregated to generate the corresponding genre archetype. For example, the genre archetype may be generated by averaging the standardized historical data of the metric across all the identified seasonal titles. In another aspect, the genre archetype may be generated by performing other mathematical and/or statistical operations on the standardized inflow data of the individual identified seasonal titles. For example, the individual identified seasonal titles may be assigned with respective weighing factors, which may be associated how representative the individual identified seasonal titles are within the genre. As such, the generated genre archetype may be influenced to a greater extend by certain seasonal titles than others within the genre.

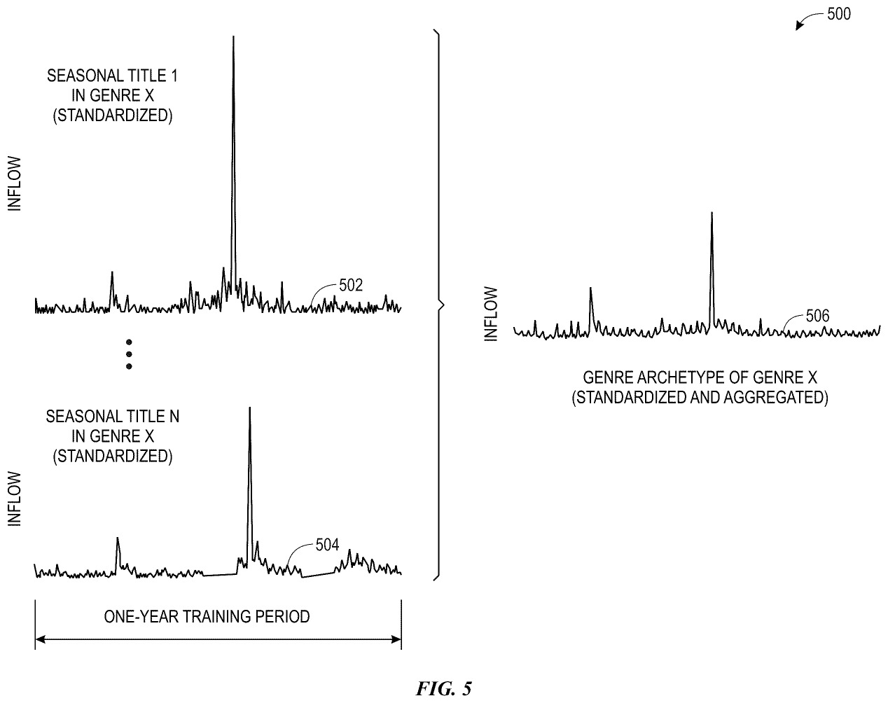

FIG. 5 is a diagram illustrating an example implementation 500 of the generation of a genre archetype, in accordance with the example described above with respect to implementation 400 of FIG. 4. As illustrated, the historical inflow data of the first seasonal title (e.g., seasonal title 1 as illustrated in FIG. 5) of the genre (e.g., genre X as illustrated in FIG. 5) has been standardized to generate first standardized inflow data 502; similarly, the historical inflow data of the second seasonal title (e.g., seasonal title N as illustrated in FIG. 5) of the same genre have been standardized to generate second standardized inflow data 504. Note that the first standardized inflow data 502 and the second standardized inflow data 504 herein may appear notably different from the first remaining historical inflow data 406 and the second remaining historical inflow data 408 in FIG. 4, respectively. This is because the metric standardization performed on the first remaining historical inflow data 406 and the second remaining historical inflow data 408 removes the extreme datapoints therein. In the current example, a genre archetype 506 corresponding to the genre (e.g., genre X as illustrated in FIG. 5) is generated by aggregating the individual standardized inflow data, which include the first standardized inflow data 502 and the second standardized inflow data 504. Similarly, one or more other genre archetypes corresponding to one or more other genre may be generated through the process 310. As such, the forecasting services 110 may store all generated genre archetypes in a memory and select a specific genre archetype from the stored genre archetypes at a later time in accordance with a genre of a content title of interest.

It should be appreciated that the genre archetype corresponding to a specific genre may be updated over time. For example, the content provision platform 102 and/or content provider 104 may create new content titles or remove underperformed content titles over time, and, accordingly, a new genre archetype may be generated to capture any changes within the specific genre. The forecasting services 110 may update the genre archetype periodically to reflect a most updated list of content titles in the respective genre.

In an aspect, the process 320, as illustrated in FIG. 3B may be executed automatically proceeding the process 310. As discussed previously, the process 320 may be used for transforming a genre archetype to generate genre-adaptive training data specific to a seasonal title of interest.

The process 320 may include receiving (block 322) historical inflow data of a seasonal title of interest with limited historical data. The historical inflow data of the seasonal title of interest may be provided by the content provision platform 102 and/or content provider 104. The historical inflow data may include limited historical data up to the evaluation period, which may be excluded after performing timeframe standardization on inflow data of the identified titles during the process 310.

The process 320 may include obtaining (block 324) a genre archetype corresponding to the genre of the seasonal title of interest. In an aspect, the genre archetype may be generated upon receiving a forecasting request to predict inflow for the seasonal title of interest. In another aspect, a plurality of genre archetypes, each corresponding to a genre, may be generated at an earlier time and stored in a memory of the forecasting services 110. In this aspect, the genre archetype corresponding to the genre of the seasonal title of interest may be selected from the plurality of genre archetypes for further processing.

The process 320 may further include performing (block 326) a transformation on the genre archetype corresponding to the genre of the seasonal title of interest to generate genre-adaptive training data for forecasting inflow of the seasonal title of interest. The transformation is applied on the genre archetype, such that the genre archetype is scaled to resemble the historical inflow data of the seasonal title of interest. For example, a transformation based on a median and an interquartile range of the seasonal title may be applied on the genre archetype, such that a transformed scale of the genre archetype may match a scale of the historical inflow data of the seasonal title of interest. More specifically, the transformation may include first dividing the genre archetype by the median and then adding the interquartile range thereto. The transformed genre archetype may be inputted to a forecasting model as training data for forecasting inflow of the seasonal title of interest.

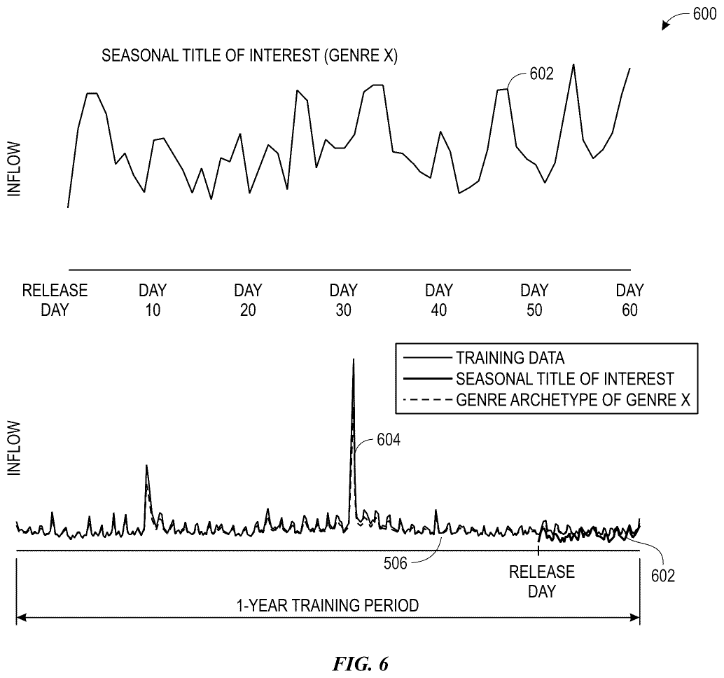

FIG. 6 is a diagram illustrating an example implementation 600 of the generation of training data based on a genre archetype in accordance with the example described above with respect to implementation 400 of FIG. 4 and implementation 500 of FIG. 5. As illustrated, a seasonal title of interest has limited historical inflow data 602, where the limited historical inflow data contains only 60 days of data. The genre archetype 506, which is previously illustrated in FIG. 5, corresponds to a genre the seasonal title of interest belongs to and is accordingly provided to generate genre-adaptive training data specific to the seasonal title of interest. In the current example, a transformation is applied to the genre archetype 506 to generate a transformed genre archetype 604, which is later supplied as training data to a forecasting model of the forecasting services 110 to forecast inflow for the seasonal title of interest. As such, instead of the limited historical inflow data of the seasonal title of interest, the forecasting model may study from the transformed genre archetype 604, which is indicative of a broader range of historical inflow data generated based on one year of individual inflow data of other titles within the same genre.

Indeed, by extending the existing forecasting methodology for seasonal titles to include dynamic generation of training data based on other titles within the same genre, a vast forecasting improvement may be observed among seasonal titles with limited historical data. This improvement is attributed to the new methodology described herein, where the seasonal titles with limited historical data that may benefit from such dynamic generation of training data are addressed appropriately.

Having discussed the process for generating training data for forecasting inflow of a seasonal title of interest with limited historical data based on a transformed genre archetype, the discussion turns to the process for generating training data for forecasting inflow of a non-seasonal title of interest with limited historical data based on a dynamically fitted exponential curve.

It becomes apparent that non-seasonal titles predominantly exhibit an exponential decaying trend in inflow (i.e., fewer paid subscribers join the streaming platform for this title over time). This decay pattern makes sense given the nature of consumer patterns within the streaming industry. Accordingly, streaming services (e.g., the streaming services 110) may implement dynamic modeling techniques including exponential fitting techniques for forecasting non-seasonal titles, especially those with sufficient history, where exponential fitting techniques may include finding the best-fit exponential curve of the historical data. For example, the inflow of a non-seasonal title, f(x), as a function of number of days since the title of interest becomes available, x, may be fitted through an analytic exponential curve in the form of Eq. 1 below,

$$f ( x ) = b {e}^{- c x} , \qquad ( Eq . 1 )$$

where b is inflow of the title of interest on first available day and c is the decay rate of inflow.

However, the existing techniques do not forecast non-seasonal titles with limited historical data well; regardless of which forecasting model is used, the forecasting model is provided with limited historical data to study from. In contrast, as will be illustrated in more detail below, the present disclosure provides an improved method to provide efficient and accurate prediction/forecasting of inflow for non-seasonal titles with limited historical data. Specifically, the present disclosure provides an adaptive method to generate training data. Instead of being confined to the limited historical data of a non-seasonal title, the forecasting model may be trained with dynamically generated adaptive training data based on the limited historical data and/or historical data of one or more other non-seasonal titles with sufficient history. FIG. 7 is a flowchart illustrating a process 700 for generating training data for forecasting inflow of a non-seasonal title of interest with limited historical data based on a dynamically fitted exponential curve.

It should be appreciated that the process 700, similar to process 300, is not limited to forecasting inflow associated with a non-seasonal title of interest; instead, the process 700 may be adopted to forecast any performance metric associated with the non-seasonal title of interest, such as number of hours watched of a particular title, ad revenue of a particular title (which might include number of ads watched, etc.) and other useful metrics. Further, while the current discussion focuses primarily on dynamic generation of training data with exponential curve fitting techniques, this discussion is not intended to limit the current techniques to use of exponential curve fitting techniques. Indeed, while exponential curve fitting may be used for a wide variety of use cases, other curve fitting techniques, such as polynomial curve fitting and/or linear curve fitting may be more suitable in other use cases.

With the foregoing in mind, the process 700 may include receiving (block 702) historical inflow data of the metric associated with a non-seasonal title of interest with limited historical data. The historical inflow data of the non-seasonal title of interest may be provided by the content provision platform 102 and/or content provider 104. In some aspects, the historical inflow data may include limited historical data up to an evaluation period.

As illustrated, the process 700 may include determining (decision block 704) whether the non-seasonal title of interest has at least 10 days of history. In another aspect, the process 700 may determine whether the non-seasonal title of interest has any different minimum number of days of history, such as 1, 2, 3, 4, 5, 6, or more days. Depending on whether the non-seasonal title of interest has a minimum number of days of history, such as 10 days of history, training data may be generated through a different method. For example, a first method to generate training data may be better suited for non-seasonal titles with less than 10 days of history, but a second method to generate training data may be better suited for non-seasonal titles with at least 10 days of history. The process 700, therefore, is intended to categorize the non-seasonal title of interest to dynamically generate a decay rate of the exponential decay, which is to be used in a forecasting model as the training data. Continuing with FIG. 7, the process 700 is strategically set to determine whether the non-seasonal title of interest has at least 10 days of history, such that a corresponding method will be used to generate the training data specific to the non-seasonal title of interest.

If, at decision block 704, the non-seasonal title of interest is determined to have more than 10 days of history, the process 700 may proceed to generate (block 706) an analytic exponential curve based on a title decay rate, which is specific to the non-seasonal title of interest. The title decay rate may be calculated based on a beginning portion and an ending portion of the historical inflow data of the non-seasonal title of interest.

The beginning portion and ending portion may be set to a specific number of days from the first day of inflow data and a specific number of days toward the last day of inflow data of the non-seasonal title of interest, respectively. Alternatively, the beginning portion and ending portion may be set to a specific beginning percentage and ending percentage of the historical inflow data of the non-seasonal title of interest, respectively. In an aspect, the beginning portion may be set to an aggregation (e.g., a mean) of the first 5% of the historical inflow data and the ending portion may be set to an aggregation (e.g., a mean) of the last 5% of the historical inflow data. As a more specific example, the title decay rate, cₜᵢₜₗₑ, may be calculated through Eq. 2 below,

$${c}_{title} = \frac{1}{days} ln \frac{{f}_{beginning}}{{f}_{ending}} , \qquad ( Eq . 2 )$$

where days is the number of days of the historical inflow data, f_{beginning} is the mean of the first 5% of the historical inflow data, and f_{ending} is the mean of the last 5% of the historical inflow data.

The range of the beginning and ending portions may be tuned for specific use cases/metrics to be forecasted. For example, with respect to forecasting inflow, after extensive experimentation and tuning, it has been observed that setting the beginning portion to the mean of the first 5% of the historical inflow data and the ending portion to the mean of the last 5% of the historical inflow data provides much improved accuracy. Different portion ranges could be tuned for other use cases, such as forecasted viewership (e.g., number of users that completed viewing of the title) or other metrics. In an aspect, different portion ranges may be tuned to prevent over-fitting and/or under-fitting.

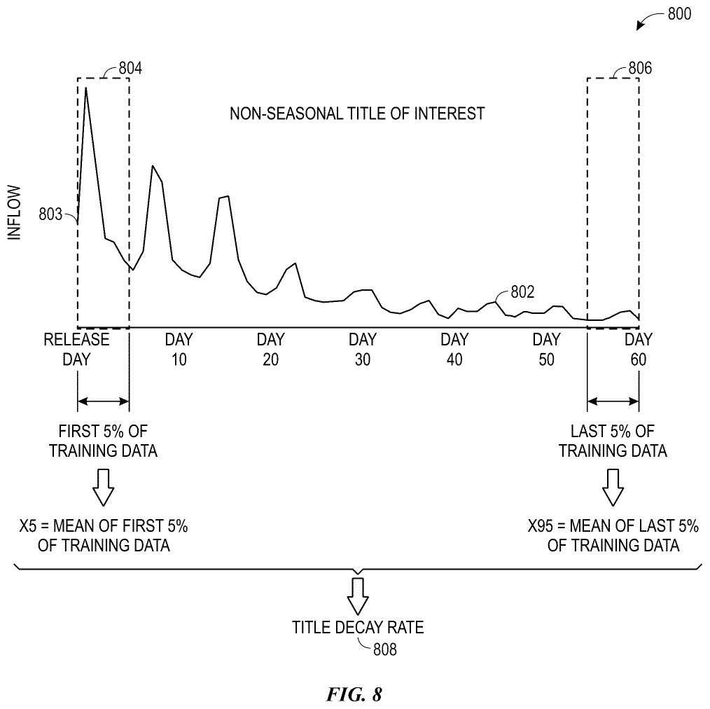

FIG. 8 is a diagram illustrating an example implementation 800 of the decay rate calculation in accordance with the example described above with respect to process 700 of FIG. 7. As illustrated, inflow data 802 for a particular non-seasonal title of interest with 60 days of history is supplied, where the inflow data 802 includes at least inflow datapoint on first available day 803. As mentioned above, in the current example, the beginning portion 804 is identified as the mean of the first 5% of the historical inflow data (here denoted as x₅). The ending portion 806 is identified as the mean of the last 5% of the historical inflow data (here denoted as x₉₅). As mentioned above, the portion ranges can be optimized for specific uses or purposes. Based on the beginning portion and the ending portion of the historical inflow data of the non-seasonal title of interest, a title decay rate 808, specific to the particular non-seasonal title of interest, may be calculated.

Returning to FIG. 7, when the non-seasonal title of interest has an extremely short history, the title decay rate calculated with the limited data may be drastically different from the actual decay rate observed at a later time, as the initial interest of the content may not have been settled. As such, a decay rate of the exponential decay is generated based on one or more titles other than the title of interest for such non-seasonal title of interest.

Accordingly, if, at decision block 704, the non-seasonal title of interest is determined to not have more than 10 days of history, the process 700 may proceed to generate (block 708) an analytic exponential curve based on a genre decay rate. The genre decay rate is, in contrast to the title decay rate, calculated based on eligible non-seasonal titles that are within the same genre as the non-seasonal title of interest. The eligible non-seasonal titles may include one or more other non-seasonal titles with sufficient history within the same genre as the non-seasonal title of interest. One or more respective title decay rates may be calculated for the individual one or more other non-seasonal titles. The one or more title decay rates of the one or more other non-seasonal titles may be aggregated to generate a genre decay rate. For example, the genre decay rate may be a mean of the one or more title decay rates of the one or more other non-seasonal titles. The genre decay rate may be more representative of the actual decay rate of the non-seasonal title of interest having an extremely short history, compared to the title decay rate specific to the non-seasonal title of interest.

In an aspect, the forecasting services 110 may store the genre decay rate specific to a genre in a memory. As such, if the forecasting services 110 receive an additional forecasting request to forecast inflow for an additional non-seasonal title of interest that belongs to the genre, the forecasting services 110 may directly look up the stored genre decay rate from the memory. It should be appreciated that the genre decay rate corresponding to a specific genre may be updated over time. For example, the content provision platform 102 and/or content provider 104 may create new content titles or remove underperformed content titles over time, and, accordingly, a new genre decay rate may be generated to capture any changes within the specific genre. In another aspect, the forecasting services 110 may update the genre decay rate periodically to reflect a most updated list of content titles in the respective genre.

It should also be appreciated that a plurality of genre decay rates corresponding to a plurality of genres may be generated. The generated plurality of genre decay rates may be stored in the memory in the forecasting services 110. As such, the forecasting services 110 may select a genre decay rate specific to the non-seasonal title of interest from the plurality of genre decay rates stored in the memory.

Regardless of which decay rate is used, the process 700 may include generating (block 710) training data for forecasting the metric of the non-seasonal title of interest based on the dynamically generated decay rate. In some aspects, an analytic exponential curve generated based on the dynamically generated decay rate is inputted to a forecasting model as training data for forecasting inflow of the non-seasonal title of interest. That is, the analytic exponential curve, in the form of Eq. 1, for a non-seasonal title of interest with more than 10 days of history may become Eq. 3 as shown below,

$$f ( x ) = b {e}^{- {c}_{t i t l e} x} , \qquad ( Eq . 3 )$$

where b is the inflow of the title of interest on the first available day (e.g., inflow datapoint 803) and cₜᵢₜₗₑ is the title decay rate (e.g., the title decay rate 808); however, the exponential curve for a non-seasonal title of interest with no more than 10 days of history may become Eq. 4 as shown below,

$$f ( x ) = b {e}^{- {c}_{g e n r e} x} , \qquad ( Eq . 4 )$$

where c_{genre} is the genre decay rate (which may be calculated by aggregating a plurality of title decay rates).

Indeed, by extending the existing forecasting methodology for non-seasonal titles to include dynamic generation of training data, a vast forecasting improvement was observed among non-seasonal titles with limited historical data. This improvement is attributed to the new methodology described herein, where the non-seasonal titles with limited historical data that may benefit from such dynamic generation of training data are addressed appropriately.

The technical effects of the present disclosure include a prediction/forecasting service that dynamically generate training data for content titles that have limited historical data. Specifically, the training data may be generated based on the limited historical data of the title of interest and/or historical data of other titles having sufficient historical data within the same genre as the title of interest. A corresponding method of various methods for generating training data may be executed, based upon characteristics of the content title of interest, such as an indication of whether or not the title is associated with a seasonal trend. By training the forecasting system with carefully prepared training data, the forecasting system is enabled to generate accurate and efficient forecasts based upon the training data without reliance on human subjectivity.

While only certain features of the invention have been illustrated and described herein, many modifications and changes will occur to those skilled in the art. It is, therefore, to be understood that the appended claims are intended to cover all such modifications and changes as fall within the true spirit of the invention.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function) . . . ”, it is intended that such elements are to be interpreted under 35 U.S.C. 112(f). However, for any claims containing elements designated in any other manner, it is intended that such elements are not to be interpreted under 35 U.S.C. 112(f).

1. A computing system, comprising:
a processor; and
memory comprising computer-readable instructions that, when executed by the processor, cause the computer system to:
determine for a content title of interest whether historical data for a metric satisfies a time threshold;
when the historical data of the metric is equal to or greater than the time threshold:
generate training data based on a title decay rate; and
when the historical data of the metric is less than the time threshold:
generate training data based on a genre decay rate, wherein the genre decay rate is associated with a content genre of the content title of interest and generated based on one or more other content titles, wherein the one or more content titles belong to the content genre; and
forecast the metric associated with the content title of interest using the generated training data applied to a forecasting model.

2. The computing system of claim 1, wherein the time threshold is 10 days.

3. The computing system of claim 1, wherein the memory comprises computer-readable instructions that, when executed by the one or more processors, cause the computer system to calculate the title decay rate based on a beginning portion and an ending portion of the historical data of the metric associated with the content title of interest.

4. The computing system of claim 3, wherein the beginning portion of the historical data of the metric is a mean of a first percentage of the historical data, and the ending portion of the historical data of the metric is a mean of a last percentage of the historical data.

5. The computing system of claim 1, wherein the memory comprises computer-readable instructions that, when executed by the one or more processors, cause the computer system to generate the genre decay rate by aggregating one or more title decay rates of the one or more other content titles.

6. The computing system of claim 1, wherein the metric comprises an inflow of the content title.

7. The computing system of claim 6, wherein the inflow is specific to paid subscribers of a content provision platform of the content title, a particular tier of paid subscribers, or an ad-supported tier of subscribers.

8. A computer-implemented method, comprising:
determining for a content title of interest whether historical data for a metric satisfies a time threshold;
when the historical data of the metric is equal to or greater than the time threshold:
generating training data based on a title decay rate; and
when the historical data of the metric is less than the time threshold:
generating training data based on a genre decay rate, wherein the genre decay rate is associated with a content genre of the content title of interest and generated based on one or more other content titles, wherein the one or more content titles belong to the content genre; and
forecasting the metric associated with the content title of interest using the generated training data applied to a forecasting model.

9. The computer-implemented method of claim 8, wherein time threshold is 10 days.

10. The computer-implemented method of claim 8, comprising calculating the title decay rate based on a beginning portion and an ending portion of the historical data of the metric associated with the content title of interest.

11. The computer-implemented method of claim 10, wherein the beginning portion of the historical data of the metric is a mean of a first percentage of the historical data, and the ending portion of the historical data of the metric is a mean of a last percentage of the historical data.

12. The computer-implemented method of claim 8, comprising generating the genre decay rate by aggregating one or more title decay rates of the one or more other content titles.

13. The computer-implemented method of claim 8, wherein:
the metric comprises an inflow of the content title; and
the inflow is specific to paid subscribers of a content provision platform of the content title, a particular tier of paid subscribers, or an ad-supported tier of subscribers.

14. A computing system, comprising:
a processor; and
memory comprising computer-readable instructions that, when executed by the processor, cause the computer system to:
determine for a content title of interest whether the content title is associated with a seasonal trend;
when the content title of interest is associated with the seasonal trend:
generate training data via a first process; and
when the content title of interest is not associated with the seasonal trend;
generate training data via a second process; and
forecast a metric associated with the content title of interest using the generated training data applied to a forecasting model.

15. The computing system of claim 14, wherein the first process comprises:
receiving historical data of the metric associated with the content title of interest, wherein the content title of interest belongs to a content genre;
obtaining a genre archetype corresponding to the content genre, wherein the genre archetype is generated based on historical data of the metric associated with one or more other content titles, wherein the one or more other content titles belong to the content genre; and
performing a transformation on the genre archetype to generate training data for a forecasting model to forecast the metric associated with the content title.

16. The computing system of claim 15, wherein the genre archetype is obtained by:
for each of the one or more other content titles, generating respective standardized historical data of the metric; and
generating the genre archetype based on the standardized historical data of the metric associated with the one or more other content titles.

17. The computing system of claim 14, wherein the second process comprises:
determining for the content title of interest whether historical data for a metric satisfies a time threshold; and
when the historical data of the metric is equal to or greater than the time threshold:
generating training data based on a title decay rate; and
when the historical data of the metric is less than the time threshold:
generating training data based on a genre decay rate, wherein the genre decay rate is associated with a content genre of the content title of interest and generated based on one or more other content titles, wherein the one or more content titles belong to the content genre.

18. The computing system of claim 17, wherein the genre decay rate is generated by aggregating one or more title decay rates of the one or more other content titles.

19. The computing system of claim 14, wherein:
the metric comprises an inflow of the content title; and
the inflow is specific to paid subscribers of a content provision platform of the content title, a particular tier of paid subscribers, or an ad-supported tier of subscribers.

20. The computing system of claim 14, comprises determining to remove the content title of interest from a streaming platform based on the generated forecast.
